(19) United States
(12) Patent Application Publication
(10) Pub. No.: US 2026/0186301 A1
(43) Pub. Date: Jul. 2, 2026

(54) DISPLAY APPARATUS WITH MULTIPLE CONFIGURATIONS

(71) Applicant: VOLKSWAGEN AKTIENGESELLSCHAFT, WOLFSBURG (DE)

(72) Inventors: Armin Fatic, San Mateo, CA (US); Alexander Ksoll, Palo Alto, CA (US); Brett LaBar, Belmont, CA (US); Christoph Kaeppner, Wolfsburg (DE)

(21) Appl. No.: 19/005,072

(22) Filed: Dec. 30, 2024

(51) Int. Cl. G02B 27/01; B60K 35/28; B60K 35/53; G06F 3/14

(52) U.S. Cl. CPC G02B 27/0149; G02B 27/0101; G02B 27/0179; G06F 3/14; B60K 35/28; B60K 35/53; G02B 2027/0154

(57) ABSTRACT

A vehicle is provided. The vehicle includes a display configured to present content to a user. The display is movable between at least a first configuration and a second configuration. The vehicle also includes a movement mechanism configured to move the display between the first configuration and the second configuration. The vehicle further includes a redirection device disposed adjacent to the display. The redirection device is configured to redirect the content presented by the display to a viewing point when the display is in the first configuration. The vehicle further includes an input device configured to receive user input. The movement mechanism moves the display between the first configuration and the second configuration based on the user input.

### TECHNICAL FIELD

Aspects of the present disclosure relate to a display apparatus, and more particularly, to a display apparatus with multiple configurations.

### BACKGROUND

As multimedia content (e.g., social media content, streaming content, etc.) becomes ever more prevalent, vehicles often incorporate displays for users to view the multimedia content. For example, vehicles often include displays with larger screens and pillar-to-pillar displays to allow users to view more content. Many vehicles include statically positioned or stationary displays. For example, a vehicle may include a display that is positioned in a center of a dashboard of the vehicle.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example vehicle, in accordance with one or more embodiments of the present disclosure.

FIG. 2 is a diagram illustrating an example interface system, in accordance with one or more embodiments of the present disclosure.

FIG. 3 is a diagram illustrating an example vehicle and interface system, in accordance with some embodiments of the present disclosure.

FIG. 4 is a diagram illustrating an example vehicle and interface system, in accordance with some embodiments of the present disclosure.

FIG. 5 is a diagram illustrating an example vehicle and interface system, in accordance with some embodiments of the present disclosure.

FIG. 6 is a side view of an example interface system, in accordance with some embodiments of the present disclosure.

FIG. 7 is a side view of an example interface system, in accordance with some embodiments of the present disclosure.

FIG. 8 is a side view of an example interface system, in accordance with some embodiments of the present disclosure.

FIG. 9 is a diagram illustrating the operation of an example redirection device, in accordance with some embodiments of the present disclosure.

FIG. 10 is a diagram illustrating the operation of an example redirection device, in accordance with some embodiments of the present disclosure.

FIG. 11 is a diagram illustrating an example vehicle and an example interface system, in accordance with some embodiments of the present disclosure.

FIG. 12 is a flow diagram of a method for operating an interface system, in accordance with one or more embodiments of the present disclosure.

FIG. 13 is a block diagram of an example computing device that may perform one or more of the operations described herein, in accordance with some embodiments of the present disclosure.

### DETAILED DESCRIPTION

As discussed above, vehicles often include displays with larger screens and pillar-to-pillar displays to allow users to view more content. The displays are generally statically positioned or stationary. In addition, the displays are often positioned lower/closer to the dashboard and positioned closer to the center of the dashboard to allow for more visibility of objects through a windshield of the vehicle. For example, the displays are often positioned lower to prevent the displays from obscuring a user's view of the road and/or other objects outside the vehicle. Positioning a display lower in the dashboard and towards the center of the dashboard may result in a sub-optimal viewing experience for the user. For example, if the display is lowered and centered in the dashboard, the user may not be able to comfortably view content for a longer period of time (e.g., the user may have to turn their head towards the center and downward which may result in a more uncomfortable experience). However, having a larger display that is positioned higher may obstruct a driver's view of the road, which may result in a more unsafe situation/scenario when the user is operating the vehicle (e.g., driving the vehicle).

The embodiments, implementations, and/or examples, described provide an interface system that includes one or more display and one or more redirection devices. The display may be movable between an open configuration and a closed configuration. In the closed configuration, the display may be positioned within and/or above a portion of a dashboard of the vehicle, allowing users (e.g., a driver) an unobstructed view (or less obstructed view) through a windshield of the vehicle. The content presented by the display when in the closed configuration may be redirected towards the viewing point of a user (e.g., viewpoint or eyes of the user) using the redirection device. This allows the display to present content to the user (e.g., vehicle information such as speed, compass direction, and driving mode, climate control settings, information about streaming music/media, media playlists, etc.) while in the closed configuration, without obstructing the user's view through the windshield. The display may also be movable to an open configuration where an entirety of the display may be visible to a user. This may allow for a more immersive experience when viewing content (e.g., multimedia content) and may allow for a more productive experience (e.g., may allow the user to view documents, text, or other content related to productivity/work). Because the display is movable between the open configuration and the closed configuration, the interface system may allow the view more content on a larger screen, while still maintaining more visibility when operating (e.g., driving) the vehicle.

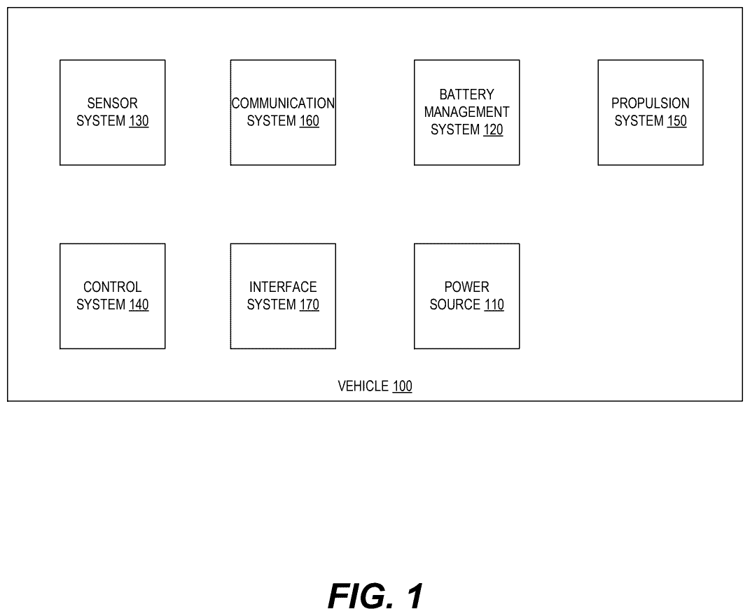

FIG. 1 is a block diagram that illustrates an example vehicle 100, in accordance with one or more embodiments of the present disclosure. In one embodiment, the vehicle 100 may be an autonomous vehicle (e.g., a self-driving vehicle). For example, the vehicle 100 may be a vehicle (e.g., car, truck, van, mini-van, semi-truck, taxi, drone, etc.) that may be capable of operating autonomously or semi-autonomously. In another embodiment, the vehicle 100 may also be a vehicle with autonomous capabilities. A vehicle with autonomous capabilities may be a vehicle that may be capable of performing some operations, actions, functions, etc., autonomously. For example, vehicle 100 may have adaptive cruise control capabilities and/or lane assist/keep capabilities. A vehicle 100 with autonomous capabilities may be referred to as a semi-autonomous vehicle.

The vehicle 100 may include various systems that allow the vehicle 100 to operate specific functions. For example, vehicle 100 includes a sensor system 130, a control system 140, a communication system 160, an interface system 170, a propulsion system 150, a power source 110, and a battery management system (BMS) 120. In other embodiments, the vehicle 100 may include more, fewer, and/or different systems, and each system may include more, fewer, and/or different components. Additionally, the systems and/or components may be combined and/or divided in any number/possibility of arrangements.

The power source 110 may be a source of energy that provides power (e.g., energy, electricity, etc.) to various components, modules, and/or systems of the vehicle 100. For example, the power source 110 may be used to power one or more of the sensor system 130, control system 140, communication system 160, interface system 170, propulsion system 150. Examples of power sources (e.g., energy sources) may include gasoline, diesel, propane, other compressed gas-based fuels, ethanol, solar panels, batteries, and other sources of electrical power. The power source 110 may be a combination of multiple power sources (e.g., may include any combination of fuel tanks, batteries, capacitors, and/or flywheels). In one embodiment, the power source 110 may be a battery (e.g., a lithium-ion battery, an electrical battery, etc.).

The BMS 120 may include various devices, systems, components, software, hardware, firmware, etc., that may monitor (e.g., detect, measure, etc.) the various characteristics of the power source 110. For example, if the power source 110 is a battery, the BMS 120 may monitor characteristics (e.g., operating parameters, conditions, etc.) such as battery temperature, battery voltage, battery current, battery charging and discharging data, state of charge of the power source 110, etc. The characteristics can be stored locally in the vehicle 100 by the BMS 120. The BMS 120 can also transmit such monitored information via the communication system 160 to other devices (e.g., to a server computer, to a cloud, etc.). The BMS 120 may also regulate the operating conditions of the power source 110. For example, the BMS 120 may cool the battery temperature to within a predefined threshold temperature. The BMS 120 may further manage, regulate, control, etc., the operation and/or usage of the power source 110.

The sensor system 130 may include one or more sensors (e.g., detectors, sensing elements, sensor devices, etc.). The one or more sensors may provide information about the operation of the vehicle 100, information about the condition of the vehicle 100, information about occupants/users of the vehicle 100, and/or information about the environment (e.g., a geographical area) where the vehicle 100 is located. The one or more sensors may be coupled to various types of communication interfaces (e.g., wired interfaces, wireless interfaces, etc.) to provide sensor data to other systems of the vehicle 100. For example, a sensor may be coupled to a storage device (e.g., a memory, a cache, a buffer, a disk drive, flash memory, etc.) and/or a computing device (e.g., a processor, an ASIC, an FPGA, etc.) via a control area network (CAN) bus (or other type of communication bus, such as a Flexray). In another example, a sensor may be coupled to a storage drive and/or a computing device via Bluetooth, Wi-Fi, etc. Examples of sensors may include, but are not limited to, tire pressure sensors, steering sensors (e.g., to determine the positions/angles of one or more wheels), a compass, temperature sensors, a global positioning system (GPS) receiver/sensor, a light detection and ranging (LIDAR) device/sensor, an ultrasonic device/sensor, a camera (e.g., a video camera), a radar device/sensor, etc.

The control system 140 may include hardware, software, firmware, or a combination thereof that may control the functions, operations, actions, etc., of the vehicle 100. For example, the control system 140 may be able to control a braking system and/or an engine to control the speed and/or acceleration of the vehicle 100. In another example, the control system 140 may be able to control a steering system to turn the vehicle 100 left or right. In a further example, the control system 140 may be able to control the headlights or an all-wheel drive (AWD) system of the vehicle 100 based on weather/driving conditions (e.g., if the environment has snow/rain, if it is nighttime in the environment, etc.). The control system 140 may use sensor data and/or outputs generated by machine learning models to control the vehicle 100.

The control system 140 may use outputs generated one or more machine learning models to control the vehicle. For example, control system 140 may generate one or more steering commands based on the outputs of a machine learning model (e.g., based on objects detected by a machine learning model). The steering command may indicate the direction that a vehicle 100 should be turned (e.g., left, right, etc.) and may indicate the angle of the turn. The control system 140 may actuate one or more mechanisms/systems (e.g., a steering system, a steering wheel, etc.) to turn the vehicle 100 (e.g., to control the vehicle 100) based on the steering command. For example, the control system 140 may actuate one or more steering mechanisms that may turn/move the wheels of the vehicle by a certain number of degrees to steer the vehicle 100. The control system 140 may also control acceleration and/or deceleration of the vehicle 100. For example, the control system 140 may use the accelerator to speed up the vehicle 100 or may use the brake to slow down the vehicle 100.

The propulsion system 150 may include various devices, systems, components, software, hardware, firmware, etc., that may be used to move the vehicle 100. For example, the propulsion system 150 may include an engine/motor, an energy source, a transmission, and wheels/tires. The engine/motor may include any combination of an internal combustion engine, an electric motor (that can be powered by an electrical battery, fuel cell, and/or other energy storage device), and/or a steam engine.

The communication system 160 may include various devices, systems, components, software, hardware, firmware, etc., that allow the vehicle 100 to communicate (e.g., transmit and/or receive data) with various networks (e.g., computer networks, communication networks, etc.) and/or devices (e.g., other vehicles, server computers, etc.). For example, the communication system 160 may include antennas, network interfaces, wireless network interfaces (e.g., cellular, Wi-Fi, Bluetooth, ZigBee, ZWave, and/or other network interfaces). The communication system 160 may also allow the vehicle 100 to communicate with other vehicles (e.g., V2V communications), with infrastructure (e.g., V2I communications), and/or with other devices/networks (e.g., V2X communications).

The interface system 170 may include various devices, systems, components, software, hardware, firmware, etc., that allow the vehicle 100 to interact with external sensors, other vehicles, external computing devices, and/or a user. For example, the interface system 170 may include buttons, knobs, dials, touch screens, microphones, cameras, and/or other devices that interact with a user, present information to a user, receive user input from a user, etc. The interface system 170 may include displays (e.g., screens, liquid crystal displays, touchscreens, etc.) that may be used to present (e.g., display, show, etc.) content, information, data, etc., to a user.

In one embodiment, the interface system 170 includes one or more displays and one or more redirection devices, as discussed in more detail below. A display may be movable between an open configuration (where an entirety of the display may be directly visible) and a closed configuration. The content presented by a display when in the closed configuration may be redirected towards the viewing point of a user (e.g., viewpoint or eyes of the user) using a redirection device. This allows the display to present content to the user (e.g., vehicle information such as speed, compass direction, and driving mode, climate control settings, information about streaming music/media, media playlists, etc.) without obstructing the user's view through the windshield. When in an open configuration, an entirety of the display may be visible to a user. This may allow for a more immersive/productive experience when viewing content.

Although not illustrated in FIG. 1, the vehicle 100 may also include various computing resources and/or devices. For example, the vehicle 100 may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The vehicle 100 may also include computing devices. The computing devices may comprise any suitable type of computing device or machine that has a programmable processor including, for example, a computer. In some examples, the computing devices may include a single machine or may include multiple interconnected machines (e.g., multiple computers configured in a cluster).

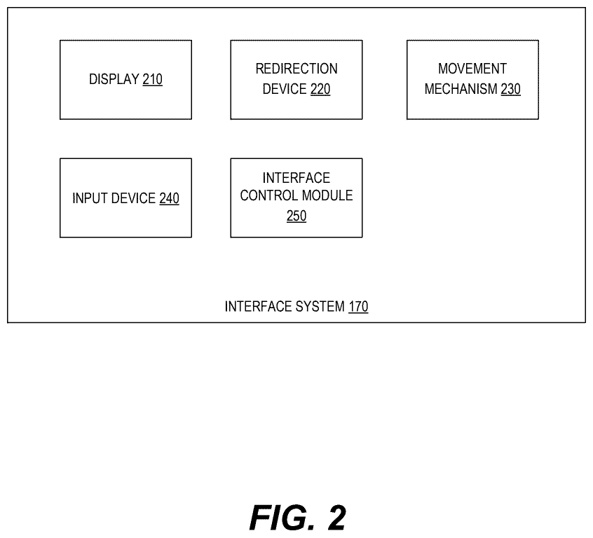

FIG. 2 is a block diagram that illustrates an example interface system 170, in accordance with one or more embodiments of the present disclosure. The interface system 170 includes a display 210, a redirection device 220, a movement mechanism 230, an input device 240, and an interface control module 250. Some or all of the device, modules, components, systems, engines, etc., illustrated in FIG. 2 may be implemented in software, hardware, firmware, or a combination thereof. The interface system 170 may be part of a vehicle (e.g., vehicle 100 illustrated in FIG. 1).

In one embodiment, the display 210 may include any combination of devices/components that may be used to display, present, show, etc., content. For example, display 210 may include one or more of a liquid crystal display (LCD), a light emitting diode (LED) display (e.g., an organic LED (OLED) display), a thin film transistor (TFT) display, a flexible/foldable display, an e-ink display, etc. The display 210 may present different types of content (e.g., different types of images, videos, graphics, text, etc.) to a user when the display 210 is in different configurations/positions. For example, the display 210 may present more immersive or entertainment related content when the display 210 is in the open configuration. In another example, the display 210 may present information related to the operation/use of the vehicle 100 when the display 210 is in the closed configuration.

In one embodiment, the display 210 may include a flexible and/or folding display. For example, the display 210 may include a flexible LCD or flexible OLED screen. This may allow the display 210 to be rolled onto a roller. For example, the display 210 may be partially rolled onto the roller when the display 210 is in the closed configuration. When in the open configuration, the display 210 may be fully (or mostly) unrolled from the roller.

In one embodiment, the redirection device 220 may include any combination of devices/components that may redirect content (e.g., redirect light, text, images, videos, etc.) presented/displayed by the display 210 to a particular viewing point (e.g., to the eyes/viewpoint of a driver/passenger of a vehicle). For example, the redirection device 220 may be a lens, prism, or some other transparent/semi-transparent component that is able to refract light (e.g., a transparent component that has flat, concave, or convex refractive surfaces). In another example, the redirection device 220 may be a mirror or some other reflective/semi-reflective component that is able to reflect light. The redirection device 220 may allow a user to indirectly view content displayed/presented by the display 210, as discussed in more detail below.

In one embodiment, the movement mechanism 230 may include devices, components, mechanisms, etc., for moving (e.g., physically moving) one or more of the display 210 and the redirection device 220. For example, the movement mechanism may include bars, rods, plates, slides, slots, grooves, wheels, gears, motors/actuators, etc., that may be used to rotate/move the display 210 and/or the redirection device 220. The movement mechanism 230 may be used to move the display 210 and/or the redirection device 220 to different configurations/positions, as discussed in more detail below.

In one embodiment, the input device 240 may be a device/component that may receive input (e.g., user input) indicating that the configuration/position of the display 210 and/or redirection device 220 should be changed. For example, the input device 240 may be a touchscreen, control pad, button, wheel/dial, slider, etc., that a user may activate (e.g., physical touch, tap, etc.) to change the configuration/position of the display 210. In another example, the input device 240 may be a camera (e.g., a video camera, an infrared camera, etc.) or some other device that may detect the movement of a user (e.g., a hand gesture, a nod, etc.) to change the configuration/position of the display 210. In a further example, the input device 240 may be a microphone or some other device that may capture/detect audio (e.g., verbal commands/sounds from a user) to change the configuration/position of the display 210.

In one embodiment, the interface control module 250 may determine whether the configuration/position of the display 210 and/or redirection device 220 may be changed. For example, based on user input (e.g., a request) received from the input device 240 and/or based on one or more conditions, parameters, criteria, etc., the interface control module 250 may determine whether the display 210 can be moved to a particular configuration/position. For example, when a vehicle is in a particular mode (e.g., a driving mode), the interface control module 250 may not allow the display 210 to be moved to an open configuration/position).

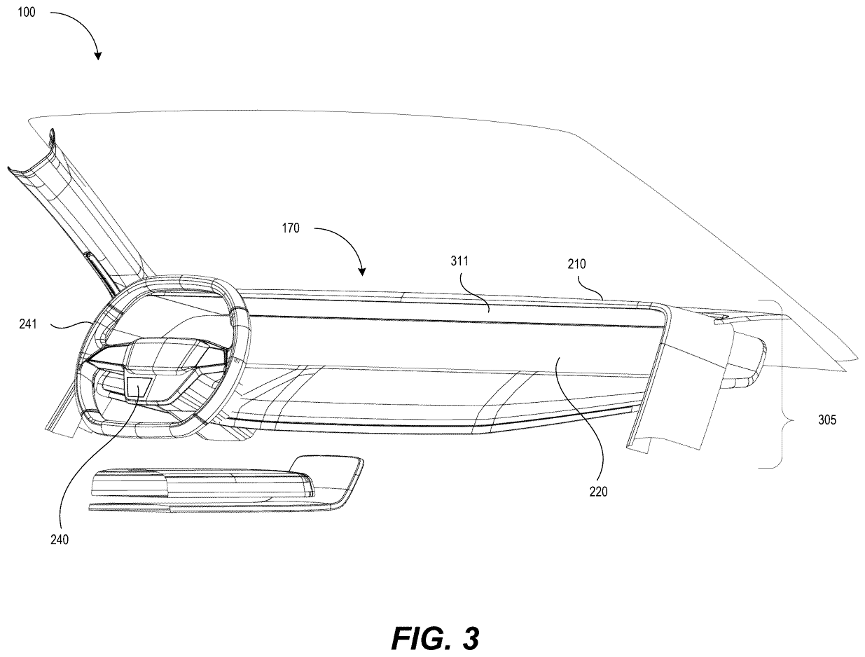

FIG. 3 is a diagram illustrating an example vehicle 100 and interface system 170, in accordance with some embodiments of the present disclosure. The vehicle 100 may be an internal combustion engine (ICE) vehicle, an electric vehicle (EV), a hybrid vehicle, an autonomous vehicle, a semi-autonomous vehicle, etc. As discussed above, the vehicle 100 includes an interface system 170 that may allow the vehicle 100 to interact with a user (e.g., a driver, a passenger, etc.), present information to a user, receive user input from a user, etc. The interface system 170 includes a display 210 and a redirection device 220. The interface system 170 may also include a movement mechanism (not illustrated in FIG. 3), as discussed in more detail below. In one embodiment, the interface system 170 (or portions of the interface system 170) may be located in the region of a dashboard 305 of the vehicle 100. For example, the interface system 170 (e.g., the display 210) may extend over the entire dashboard 305 of the vehicle 100 such that the display 210 is disposed between two A-pillars of the vehicle 100.

As discussed above, the interface system 170 includes a display 210. The display 210 may present content (e.g., text, images, video, etc.) to a user. The display 210 may have a surface 311 (e.g., a viewing surface, a viewing screen, a screen, etc.) that is used to present/display content. For example, the surface 311 may be a front surface where the pixels of the display 210 (or other active display elements) are located and/or are visible to a user (e.g., a driver, passenger, etc.).

As discussed above, the display 210 may be movable. For example, the orientation, position, angle, height/elevation, etc., of the display 210 may be moved, changed, adjusted. In one embodiment, the display 210 illustrated in FIG. 3 may be in a closed configuration (e.g., a closed position, a first configuration/position). While in the closed configuration, the surface 311 may not be visible to a user. For example, the surface 311 may be angled downward when the display 210 is in the closed configuration. The angle of the surface 311 with relation to a viewing point of the user (e.g., a viewpoint of the user) may prevent and/or may hinder a user (e.g., a driver, passenger, etc.) from viewing (e.g., directly viewing) content present by the display 210.

In one embodiment, the display 210 may be moved from another position to the closed position and vice versa, using a movement mechanism (not illustrated in FIG. 3). The movement mechanism may include any combination of motors, pistons, actuators, rails, sliders, slots, grooves, hinges, joints, and/or devices/components that may be used to move the display 210. Examples of movement mechanisms are discussed in more detail below.

In other embodiments, portions of the surface 311 (of display 210) may be visible to a user while the display 210 is in the closed configuration. For example, based on the height of the user, the user may still be able to see portions of the surface 311 when the display 210 is in the closed configuration. However, the content presented/displayed by the display 210 (while the display 210 is in the closed configuration) may not be legible, understandable, viewable, etc., when the display 210 is in the closed configuration.

In one embodiment, portions of the display 210 (e.g., a lower half or lower portion) may be retracted within the dashboard 305 and/or may cover portions of the dashboard 305 when the display 210 is in the closed configuration. For example, portions of the display 210 may retract into the dashboard 305 on rails, guides, etc., when the display 210 is in the closed configuration. In another example, portions of the display 210 may be positioned over the dashboard 305 and/or may cover portions of the dashboard 305 when the display 210 is in the closed configuration.

In one embodiment, the display 210 may still present content while the display 210 is in the closed configuration/position. For example, a portion of the display 210 (e.g., a smaller portion, a sub-portion, a sub-set of the pixels or display elements in the display 210, etc.) may be used to present content. In another example, a top/upper portion of the display 210 may be used to present content to the user via the redirection device 220, as discussed in more detail below. The display 210 may present/display a reduced amount of content when compared to the amount of content presented in an open configuration.

In one embodiment, the redirection device 220 may reflect, refract, and/or otherwise redirect content (e.g., text, images, animations, movies, etc.) displayed/presented by the display 210 (e.g., by a sub-portion or top portion of display 31) towards a viewing point of a user. This allows the content presented by the display 210 (while the display 210 is in the closed configuration) to be viewable by the user. For example, the content displayed/presented by the display 210 may be reflected and/or refracted towards the head/eyes of a user. The redirection device 220 may include one or more of a mirror (or another device with a reflective surface) and an optical prism (or another device with a refractive surface). The redirection device 220 may allow a user to indirectly view content that is displayed/presented by the display 210. For example, the user may view a reflection of the content that is presented/displayed by the 210, as discussed in more detail below. As illustrated in FIG. 3, the redirection device 220 is located adjacent, close to, or in the vicinity of the display 210.

In one embodiment, the angle of the display 210 and/or the angle of the redirection device 321 may be adjustable while the display 210 is in the closed configuration/position. For example, different users (e.g., different drivers/passengers) may have different heights which may result in different viewing points (e.g., different viewpoints where the user is able to see the redirection device 220 and/or the display 210). The movement mechanism may be able to change one or more of the angle of the display 210 and/or the angle of the redirection device 321 to accommodate different viewing points (for different users of different heights). The angle of the display 210 and/or the angle of the redirection device 321 may be adjusted automatically by the vehicle 100 based on sensor input. For example, the vehicle 100 may detect the height of a user (based on a camera sensor) and adjust the angle of the display 210 and/or the angle of the redirection device 321 automatically.

In one embodiment, the display 210 may present information related to the operation/use of the vehicle when the display 210 is in the closed configuration. For example, the display 210 may present content (e.g., text, images, videos, icons, graphics, etc.) that indicates the speed, direction, driving mode (e.g., neutral, drive, park, low gear, etc.), etc. In another example, the display 210 may present content related to climate control (e.g., an interface for managing/controlling temperature settings, air conditioning heater settings, etc.) and audio control (e.g., an interface for managing/controlling streaming music, podcasts, audio books, etc.). In a further example, display 210 may present content related to navigation (e.g., an interface for navigating/directing a user to a particular location, for viewing a map of a location, etc.).

The vehicle 100 also includes an input device 240. In one embodiment, the input device 240 may receive user input from a user (e.g., a driver) indicating whether the configuration/position of the display 210 should be changed. For example, the input device 240 may allow a user to provide input (e.g., physical input such as a tap, a touch, a click, a press, etc.) indicating that the display 210 should move to a closed position, move to an open position, etc. Although input device 240 is illustrated as part of steering wheel 241, the input device 240 may be located in other locations. For example, the input device 240 may be located in a center console of the vehicle 100, a control cluster of the vehicle 100, etc.

In some embodiments, the input device 240 may receive different types of input (e.g., user input). For example, the input device 240 may receive physical input (e.g., taps, clicks, etc.). In another example, the input device 240 may include a microphone (or other device to detecting voice/audio) and may receive audio input/data (e.g., a voice command). In a further example, the input device 240 may be a camera (or other device for capturing video/images) that may detect/capture gestures or movement of a user.

In one embodiment, the interface control module 250 (illustrated in FIG. 2) may determine whether to move the display to different configurations (e.g., to an open configuration, closed configuration, etc.). For example, when user input (requesting/indicating a change in the configuration of the display 21) is received via the input device 240, the interface control module 250 may determine whether one or more conditions (e.g., criteria, parameters, prerequisites, etc.) are satisfied. If the one or more conditions are satisfied, the interface control module 250 may move the display 210 and/or the redirection device 220 to a particular configuration/position.

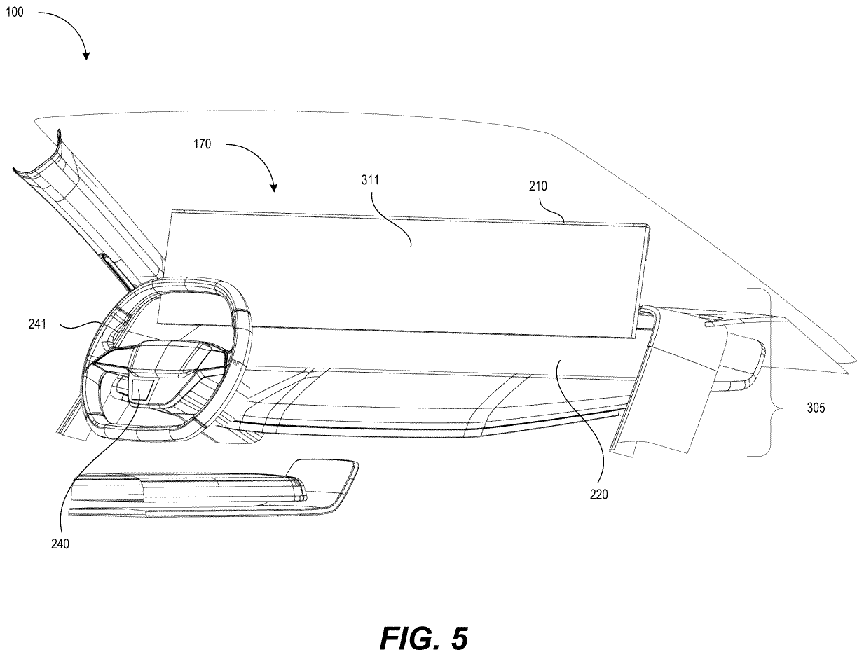

In one embodiment, the one or more conditions may include an operating mode of the vehicle 100. For example, if the vehicle 100 is in a driving mode (e.g., a mode where the vehicle 100 is not parked or is not stationary), the interface control module 250 may not allow the display 210 to move to an open configuration (illustrated in FIG. 5) because the display 210 may obstruct the view of a user in the open configuration. In another example, the one or more conditions may include the number and/or location of users in the vehicle, as discussed in more detail below. In a further example, if the vehicle is in a full autonomous driving mode (e.g., a mode where the user is not required to drive or operate the vehicle 100), the interface control module 250 may allow the display 210 to move to an open configuration.

As discussed above, having a larger display in a vehicle may provide for a more immersive and/or entertaining content viewing/consumption experience for the user. However, the larger display may obstruct a user's view of the outside of the vehicle and may be more unsafe. In the closed configuration, the display 210 may allow for an unobstructed view (or less obstructed view) through a windshield of the vehicle while still allowing useful content (e.g., content related to the use/operation of the vehicle) to be presented to the user via the redirection device 220. This allows for same display 210 to be used to present content to the user in both configurations which may allow for a safer driving experience. Using the same display 210 in different configurations may also reduce costs for the vehicle, because rather than using a smaller second display (to present content related to the user/operation of the vehicle), the same display 210 is used in conjunction with the redirection device 220.

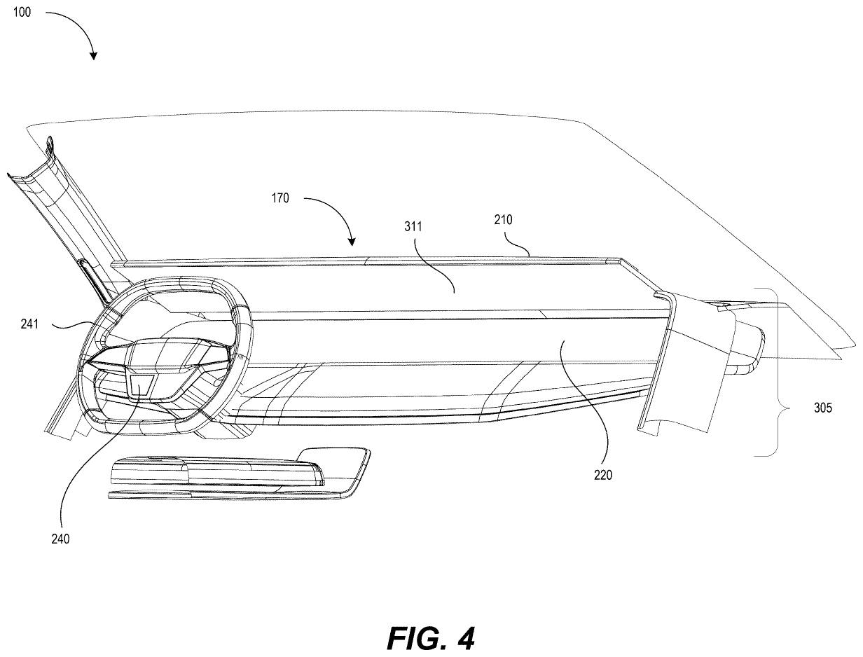

FIG. 4 is a diagram illustrating an example vehicle 100 and interface system 170, in accordance with some embodiments of the present disclosure. The interface system 170 may allow the vehicle 100 to interact with a user, present information to a user, receive user input from a user, etc. The interface system 170 includes a display 210, a redirection device 220, and a movement mechanism (not illustrated in FIG. 4), as discussed in more detail below. Display 210 may include any combination of devices/components (e.g., OLEDs, LCDs, touchscreens, etc.) that may be used to display, present, show, etc., content. The display 210 may have a surface 311 (e.g., a viewing surface, a viewing screen, a screen, etc.) that is used to present/display content. The interface system 170 (or portions of the interface system, such as display 210 and redirection device 220) may be located in the dashboard 305.

As discussed above, the display 210 may be movable between different configurations, positions, locations, etc., using the movement mechanism. For example, the interface system 170 may move the display to a different configuration/position based on user input received via the input device 240 (e.g., via taps, clicks, swipes, audio input, etc.). In one embodiment, the display 210 illustrated in FIG. 4 may be in an intermediate configuration (e.g., an intermediate position). For example, referring to FIG. 3, a user may provide user input (via input device 240 on the steering wheel 241) indicating that the display 210 should be moved from the closed configuration (illustrated in FIG. 3) to an open configuration (illustrated in FIG. 5). The intermediate configuration illustrated in FIG. 4 may be one of many intermediate configurations/positions for the display 210 as the display 210 moves between the closed configuration and open configuration (and vice versa).

In the intermediate position illustrated in FIG. 4 (and in other possible intermediate positions), the display 210 may extend towards the user (e.g., may extend towards the driver/passenger). The display 210 may be moved using a movement mechanism (not illustrated in FIG. 4). The movement mechanism may include various devices/components that may be used to move the display 210. For example, movement mechanism may include motors/actuators, belts, gears, and/or other components that may extend the display 210 along one or more rails, rods, guides, etc., towards the user.

FIG. 5 is a diagram illustrating an example vehicle 100 and interface system 170, in accordance with some embodiments of the present disclosure. The interface system 170 may allow the vehicle 100 to interact with a user, present information to a user, receive user input from a user, etc. The interface system 170 includes a display 210, a redirection device 220, and a movement mechanism (not illustrated in FIG. 5), as discussed in more detail below. Display 210 may include any combination of devices/components (e.g., OLEDs, LCDs, touchscreens, etc.) that may be used to display, present, show, etc., content. The display 210 may have a surface 311 (e.g., a viewing surface, a viewing screen, a screen, etc.) that is used to present/display content. The interface system 170 (or portions of the interface system, such as display 210 and redirection device 220) may be located in the dashboard 305.

As discussed above, the display 210 may be movable between different configurations, positions, locations, etc., using the movement mechanism based on user input received via the input device 240 on the steering wheel 241 (e.g., based on touches, taps, swipes, audio input, etc.). In one embodiment, the display 210 illustrated in FIG. 4 may be in an open configuration (e.g., an open position, a second configuration/position, etc.). For example, referring to FIG. 3, a user may provide user input indicating that the display 210 should be moved from the closed configuration (illustrated in FIG. 3) to the open configuration illustrated in FIG. 5. The display 210 may be moved from to the open configuration using a movement mechanism (not illustrated in FIG. 5). Examples of movement mechanisms are discussed in more detail below.

As illustrated in FIG. 5, the surface 311 of the display 210 is directly visible from the viewpoint of a user when the display 210 is in the open configuration. For example, a user sitting in front of the display 210 is able to directly view content that is displayed/presented by the display 210. In one embodiment, an entirety of the display 210 (e.g., the entirety of the surface 311) may be visible to the user (e.g., may be directly visible) when the display 210 is in the open configuration.

As illustrated in FIG. 5, the display 210 may obstruct the view of the user when the display 210 is in the open configuration/position. For example, because of the height of the display 210, objects behind the display (from the user's viewpoint) may be completely/partially obstructed. For example, the view of a pedestrian, another vehicle, a cyclist, a sidewalk, or some other object may completely/partially obstructed by the display 210 when the display 210 is in the open configuration.

In one embodiment, the display 210 may present entertaining and/or productivity related content when in the open configuration. For example, the display 210 may videos, streaming media (e.g., streaming movies), social media content (e.g., short videos), etc. In another example, the display may present documents, emails, slides, presentations, or other content that may related to work/productivity. The display 210 may also present other types of content when in the open configuration. For example, the display 210 may present a map of a particular location while in the open configuration or may present an interface for climate control. By having a larger display 210 (that is movable between the open configuration and closed configuration), the display 210 can provide a more immersive and/or more enjoyable content viewing experience while still providing an unobstructed or less obstructed view of the outside of the vehicle in the closed configuration.

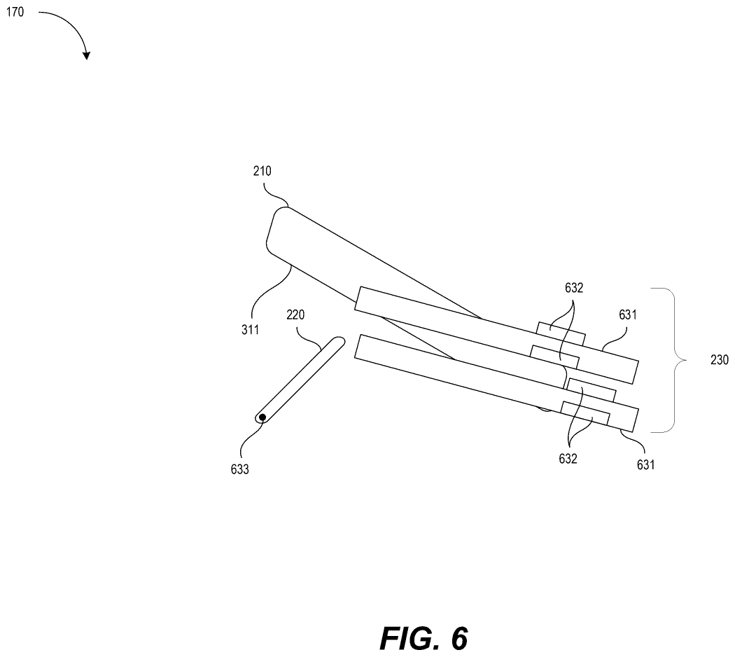

FIG. 6 is a side view of an example interface system 170 (e.g., a right-side view), in accordance with some embodiments of the present disclosure. As discussed above, the interface system 170 may allow a vehicle (e.g., vehicle 100) to interact with a user, present information to a user, receive user input from a user, etc. The interface system 170 includes a display 210 and a redirection device 220 (e.g., a mirror, a mirrored surface, a refractive lens, etc.). Display 210 may include any combination of devices/components (e.g., OLEDs, LCDs, touchscreens, etc.) that may be used to display, present, show, etc., content. The display 210 may have a surface 311 (e.g., a viewing surface, a viewing screen, a screen, etc.) that is used to present/display content. In one embodiment, the display 210 may be in a closed position/configuration (similar to the closed position/configuration illustrated in FIG. 3). The display 210 may present content to a user via the redirection device 220 (e.g., content presented by the display 210 may be reflected towards a viewing point (e.g., towards the eyes or the viewpoint of a user) by the redirection device 220.

As discussed above, the display 210 may be movable between different configurations, positions, locations, etc., using the movement mechanism 230. For example, the interface system 170 may move the display to the closed configuration/position based on user input received via an input device (e.g., e.g., via input device 240 in steering wheel 241 illustrated in FIG. 3).

The movement mechanism 230 includes rails 631 and sliders 632 that may slide or move along the rails 631. The display 210 may be mechanically coupled or attached to the sliders 632. This may allow the display 210 to move to different configurations/positions (e.g., move to an intermediate configuration or an open configuration) as the sliders 632 move along the rails 631. The movement mechanism 230 may also include motors, actuators, gears, belts, etc., that may be used to move the sliders 632 along the rails 631.

The movement mechanism 230 further includes a hinge 633. The hinge 633 may be located in and/or may be part of the redirection device 220. The hinge 633 may allow the redirection device 220 to swing about the hinge 633. For example, the redirection device 220 may swing upward or downward about (e.g., around) the hinge 633.

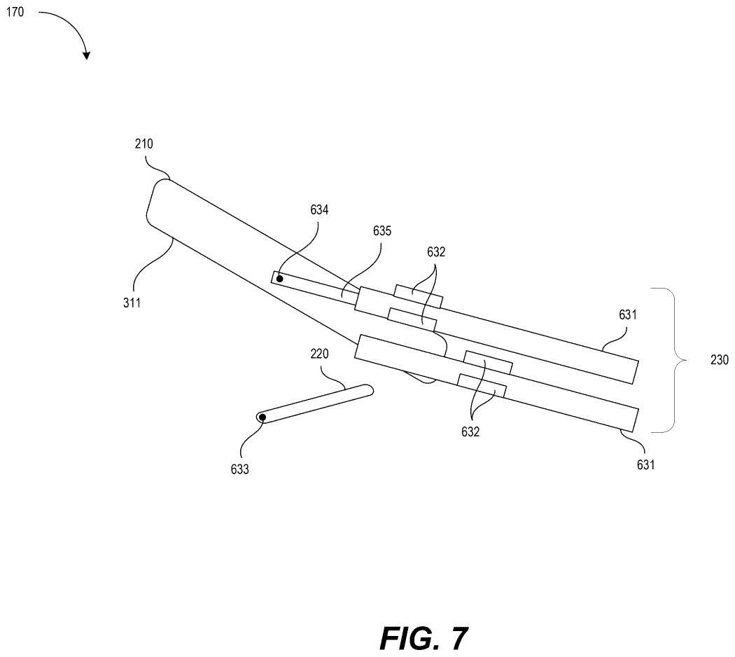

FIG. 7 is a side view of an example interface system 170 (e.g., a right-side view), in accordance with some embodiments of the present disclosure. As discussed above, the interface system 170 may allow a vehicle (e.g., vehicle 100) to interact with a user, present information to a user, receive user input from a user, etc. The interface system 170 includes a display 210, a redirection device 220, and movement mechanism 230. The display 210 may have a surface 311 (that is used to present/display content).

As discussed above, the display 210 may be movable between different configurations, positions, locations, etc., using the movement mechanism 230. For example, the interface system 170 may move the display to the closed configuration and/or open configuration based on user input received via an input device (e.g., e.g., via input device 240 in steering wheel 241 illustrated in FIG. 3). In one embodiment, the display 210 may be in an intermediate position/configuration (similar to the intermediate position/configuration illustrated in FIG. 4). The display 210 may be in the intermediate configuration (or may transition through the intermediate configuration) as the display 210 is moved between the open configuration and the closed configuration. For example, the display 210 may extend towards the left (e.g., towards a user, driver, passenger, etc.) when compared to FIG. 6.

The movement mechanism 230 includes rails 631 and sliders 632 that may slide or move along the rails 631. The display 210 may be mechanically coupled or attached to the sliders 632 to move the display 210 to different configurations/positions as the sliders 632 move along the rails 631. The movement mechanism 230 may also include motors, actuators, gears, belts, etc., that may be used to move the sliders 632 along the rails 631. The movement mechanism 230 further includes a hinge 630 and rod 635 (e.g., a bar). The hinge 630 may be located in and/or may be part of the display 210. The display 210 and/or the hinge 634 may be mechanically/physically coupled to the rod 635. The rod 635 may be pushed forward (e.g., towards the left in FIG. 7) by one or more motors, actuators, gears, belts, etc. The rod 635 may help move/push the display 210 forward (e.g., towards the left in FIG. 7) when the display 210 is moved to the intermediate configuration.

The movement mechanism 230 further includes a hinge 633 located in the redirection device 220. The hinge 633 may allow the redirection device 220 to swing about the hinge 633. When compared to FIG. 6, the redirection device 220 may swing downwards about the hinge 633 as the display 210 is moved to the intermediate configuration.

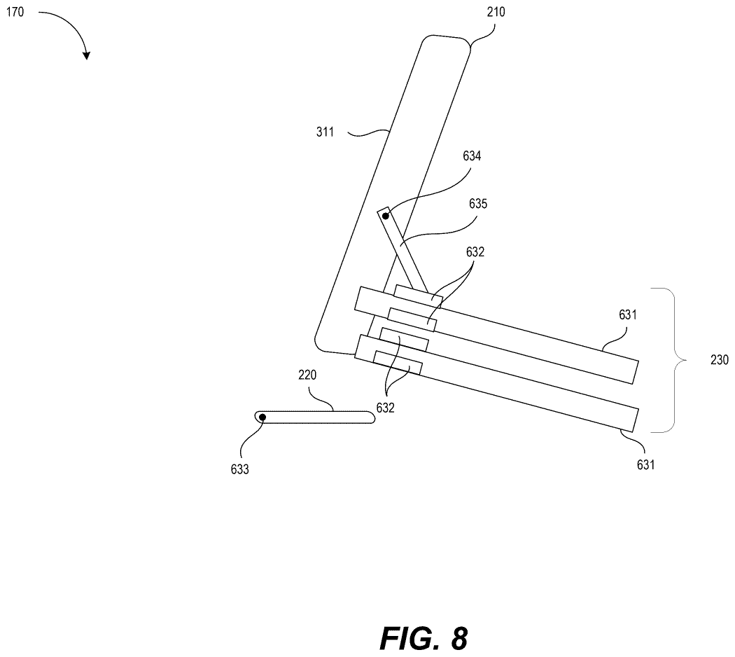

FIG. 8 is a side view of an example interface system 170 (e.g., a right-side view), in accordance with some embodiments of the present disclosure. As discussed above, the interface system 170 may allow a vehicle (e.g., vehicle 100) to interact with a user, present information to a user, receive user input from a user, etc. The interface system 170 includes a display 210, a redirection device 220, and movement mechanism 230. The display 210 may have a surface 311 (that is used to present/display content).

As discussed above, the display 210 may be movable between different configurations, positions, locations, etc., using the movement mechanism 230. For example, the interface system 170 may move the display to the closed configuration and/or open configuration based on user input received via an input device (e.g., e.g., via input device 240 illustrated in FIG. 3). In one embodiment, the display 210 may be in an open position/configuration (similar to the open position/configuration illustrated in FIG. 5). For example, the display 210 may swing towards the right (when compared to FIG. 7) to transition to the open configuration.

The movement mechanism 230 includes rails 631 and sliders 632 that may slide or move along the rails 631. The display 210 may be mechanically coupled or attached to the sliders 632 to move the display 210 to different configurations/positions as the sliders 632 move along the rails 631. The movement mechanism 230 may also include motors, actuators, gears, belts, etc., that may be used to move the sliders 632 along the rails 631. For example, the two lower sliders 632 may push the bottom of the display 210 towards the left of FIG. 8. The movement mechanism 230 further includes a hinge 630 and rod 635 (e.g., a bar). The hinge 630 may be located in and/or may be part of the display 210. The display 210 and the hinge 634 may be mechanically/physically coupled to the rod 635. The display 210 may rotated about the hinge 634, allowing the surface 311 of the display 210 to be angled towards the left FIG. 8 (e.g., to be angled towards a user, such as a driver/passenger).

The movement mechanism 230 further includes a hinge 633 located in the redirection device 220. The hinge 633 may allow the redirection device 220 to swing about the hinge 633. When compared to FIGS. 6 and 7, the redirection device 220 may further swing downwards about the hinge 633 (until the redirection device 220 is substantially flat) as the display 210 is moved to the open configuration.

Although the right-side view of an example interface system 170 is illustrated in FIGS. 6-8, the movement mechanism 230 may include device, components, etc., that may not be visible in the right-side view. For example, the movement mechanism 230 may include another set of rails and sliders that may be visible from a left-side view of the interface system 170. The other set of rails and other set of sliders may be arranged, positioned, in a manner that mirrors the 631 rails and sliders 632.

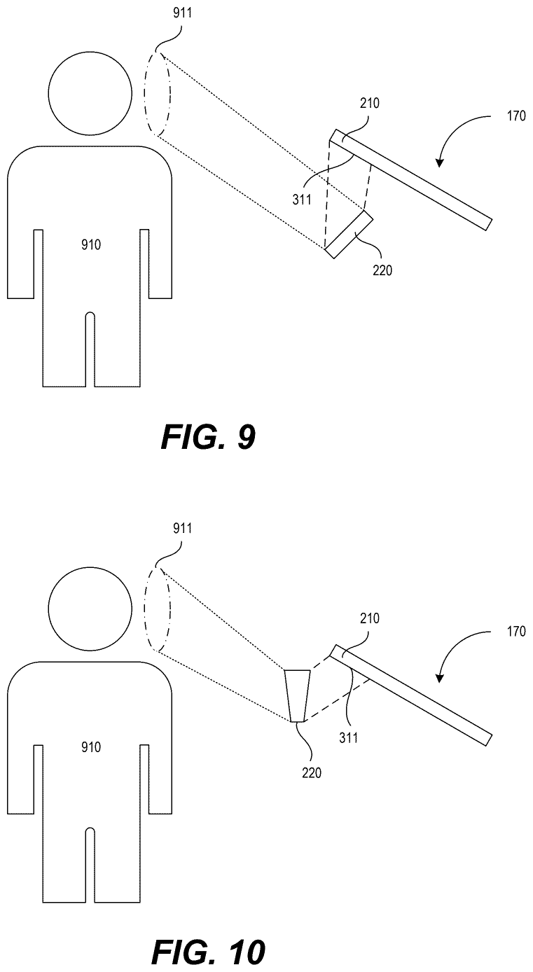

FIG. 9 is a diagram illustrating an example interface system 170, in accordance with some embodiments of the present disclosure. The interface system 170 may allow the vehicle 100 to interact with a user 910 (e.g., a driver/passenger in a vehicle), present information to a user, receive user input from a user, etc. The interface system 170 may include a display 210 and a redirection device 220. The display 210 may have a surface 311 (e.g., a viewing surface, a viewing screen, a screen, etc.) that is used to present/display content.

The display 210 may be in a closed configuration (e.g., closed position). When the display 210 is in the closed configuration a portion of the content presented on the display 210 may not may not be directly visible from the viewpoint 911 of the user 910 (e.g., may not be directly visible to the user 910). For example, the surface 311 may not be visible to the user 910 (e.g., may not be directly visible). In another example, the user 910 may not be able to read, decipher, understand, etc., content that is presented by the display 210 due to the downward angle of the surface 311.

As illustrated in FIG. 9, the display 210 may present, display, etc., content towards the redirection device 220, as illustrated by the dashed lines in FIG. 9. The redirection device 220 may be a mirror or another device with a reflective (or partially reflective) surface. The redirection device 220 may reflect the content presented by the display 210 towards the viewpoint 911 of the user 910 (e.g., toward the eyes of a driver/passenger) as illustrated by the dotted lines in FIG. 9. This allows the user 910 to indirectly view the content presented by the display 210.

FIG. 10 is a diagram illustrating an example interface system 170, in accordance with some embodiments of the present disclosure. The interface system 170 may allow the vehicle 100 to interact with a user 910 (e.g., a driver/passenger in a vehicle), present information to a user, receive user input from a user, etc. The interface system 170 may include a display 210 and a redirection device 220. The display 210 may have a surface 311 (e.g., a viewing surface, a viewing screen, a screen, etc.) that is used to present/display content.

The display 210 may be in a closed configuration (e.g., closed position). When the display 210 is in the closed configuration a portion of the content presented on the display 210 may not may not be directly visible from the viewpoint 911 of the user 910, as discussed above. As illustrated in FIG. 9, the display 210 may present, display, etc., content towards the redirection device 220, as illustrated by the dashed lines in FIG. 9. The redirection device 220 may be a lens, prism, or another device with a refractive (or partially refractive) surface. For example, the redirection device 220 may be a refractive lens with one or more of a flat refractive surface, a convex refractive surface, a concave refractive surface, etc. The redirection device 220 may refract or redirect the content presented by the display 210 towards the viewpoint 911 of the user 910 (e.g., toward the eyes of a driver/passenger), as illustrated by the dotted lines in FIG. 10. For example, different the light and/or colors presented by the display 210 may be refracted (e.g., redirected) towards the viewpoint 911 of the user 910. This allows the user 910 to indirectly view the content presented by the display 210 (e.g., see the content presented by display 210 without directly looking at the display 210).

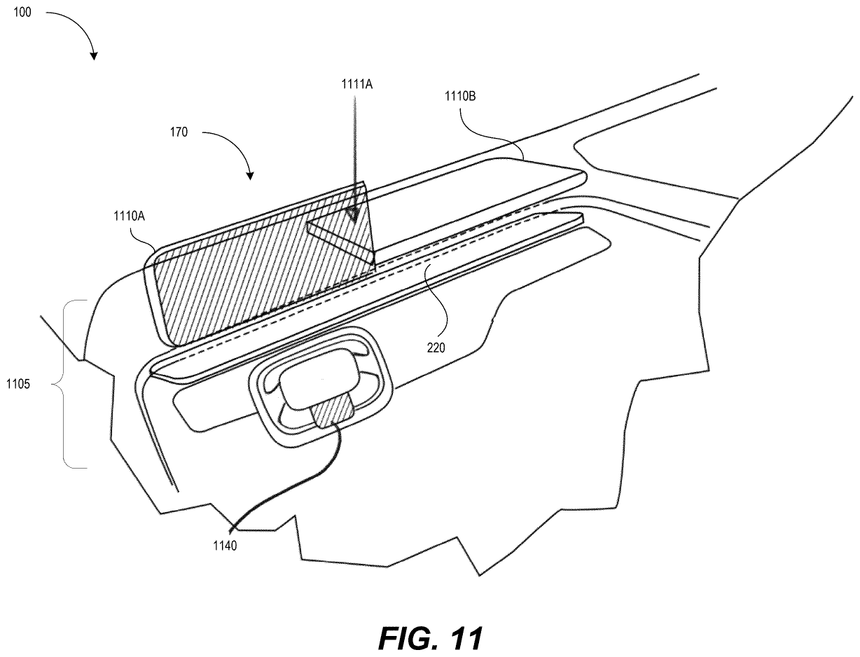

FIG. 11 is a diagram illustrating an example vehicle 100 and interface system 170, in accordance with some embodiments of the present disclosure. The interface system 170 includes multiple displays. In particular, interface system 170 includes display 1110A and display 1110B. Each of the displays 1110A and 1110B may include one or more of a liquid crystal display (LCD), a light emitting diode (LED) display (e.g., an organic LED (OLED) display), a thin film transistor (TFT) display, an e-ink display, etc., for displaying/presenting content (e.g., text, video, images, icons, etc.) to a user.

In one embodiment, the interface system 170 (or portions of the interface system 170) may be located in the region of a dashboard 1105 of the vehicle 100. For example, the interface system 170 (e.g., the displays 1110A and 1110B) may extend over the entire dashboard 1105 of the vehicle 100 such that the displays 1110A and 1110B are disposed between two A-pillars of the vehicle 100. Although two displays 1110A and 1110B are illustrated, the interface system 170 may include any number of displays in other embodiments.

Display 1110A includes a surface 1111A that use used to present content to a user (e.g., a driver, passenger, etc.). For example, surface 1111A may include pixels, LEDs, or other display elements that may be used to present/display content to the user. Display 1110B may also include a surface (not visible in FIG. 11) for presenting/displaying content to a user.

Interface system 170 also includes a redirection device 220 for redirecting (e.g., reflecting, refracting, etc.) content presented by the displays 1110A and 1110B, towards one or more viewpoints. For example, the redirection device 220 may redirect the content presented by display 1110B towards the viewpoint of a passenger of the vehicle 100. In another example, the redirection device 220 may redirect the content presented by display 1110A towards the viewpoint of a driver of the vehicle 100. Although one redirection device 220 is illustrated in FIG. 11, multiple redirection devices may be used in other embodiments. For example, there may be one redirection device for each display in the interface system 170.

The interface system 170 also includes an input device 1140. The input device 1140 may receive input (e.g., user input) indicating that the configuration/position of the display one or more of display 1110A, display 1110B, and redirection device 220 should be changed. For example, a driver of the vehicle 100 may tap the input device 1140 to move the display 1110A to a closed configuration/position. In some embodiments, display 1110A and display 1110B may be moved independent of each other. For example, display 1110A may be moved to an open configuration and display 1110B may be moved to a closed configuration. In another example, display 1110A may be moved to a closed configuration and display 1110B may be moved to an open configuration.

As discussed above, an interface control module (e.g., interface control module 250 illustrated in FIG. 2) may determine whether to move the displays 1110A and 1110B to different configurations based one or more conditions. In one embodiment, the one or more conditions may include the number and/or location of users in the vehicle. For example, if there is no passenger in the vehicle (e.g., there is nobody in the passenger side of the vehicle), the display 1110B may not move from a closed configuration to an open configuration. In another example, if there is a passenger in the vehicle, the display 1110B may be allowed to move to an open configuration even while the vehicle is in operation (e.g., while the vehicle is driving) because the display 1110B may not obstruct a driver's view of the road while the display 1110B is in an open configuration.

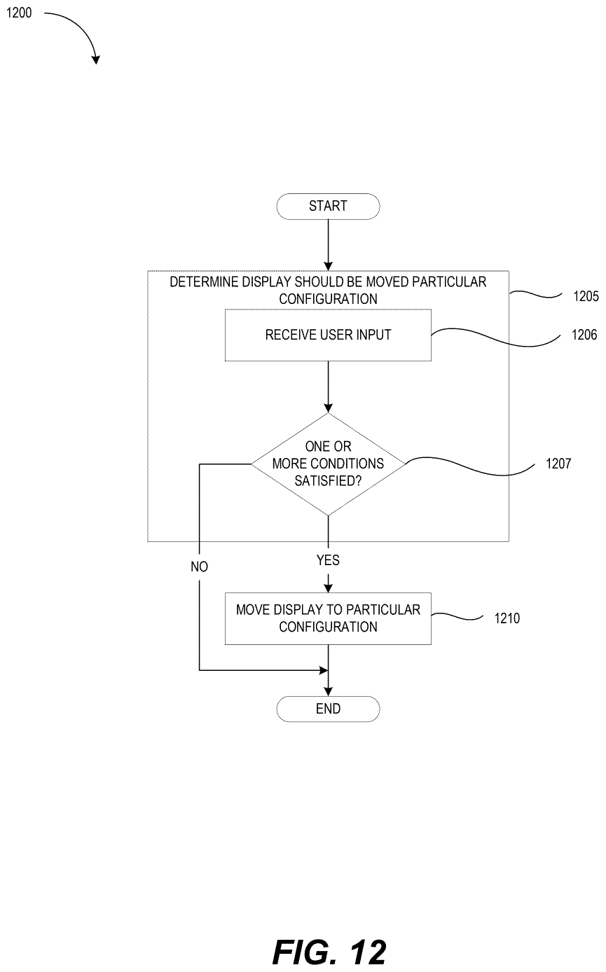

FIG. 12 is a flow diagram of a method 1200 for operating an interface system, in accordance with one or more embodiments of the present disclosure. Method 1200 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 1200 may be performed by a computing device, a vehicle, an interface system (e.g., interface system 170 illustrated in FIGS. 1-11), an interface control module (e.g., interface control module 250 illustrated in FIG. 2), and/or various components, modules, systems, etc., of the interface system (as illustrated in FIG. 2).

With reference to FIG. 12, method 1200 illustrates example functions used by various embodiments. Although specific function blocks (“blocks”) are disclosed in method 1200, such blocks are examples. That is, embodiments are well suited to performing various other blocks or variations of the blocks recited in method 1200. It is appreciated that the blocks in method 600 may be performed in an order different than presented, and that not all of the blocks in method 600 may be performed, and other blocks (which may not be included in FIG. 12) may be performed between the blocks illustrated in FIG. 12.

The method 1200 begins at block 1205 where the method 1200 may determine that a display should be moved to a particular configuration/position. For example, the method 1200 may receive user input at block 1206. The user input may indicate that the user (e.g., a driver/passenger) wants to move the display to a particular configuration (e.g., to an open configuration). At block 1207, the method 1200 may determine whether one or more conditions are satisfied. For example, the method 1200 may determine whether the vehicle is in a particular mode (e.g., a particular operating mode, such as drive, park, full autonomous driving, etc.). In another example, the method 1200 may determine whether there is a user at a particular location in the vehicle (e.g., whether there is a passenger in the vehicle). If the one or more conditions are satisfied the method 1200 may proceed to block 1210, where the method 1200 may move the display to the particular configuration. For example, the method 1200 may activate and/or use a movement mechanism to move the display to the particular configuration. If the one or more conditions are not satisfied, the method 1200 may end.

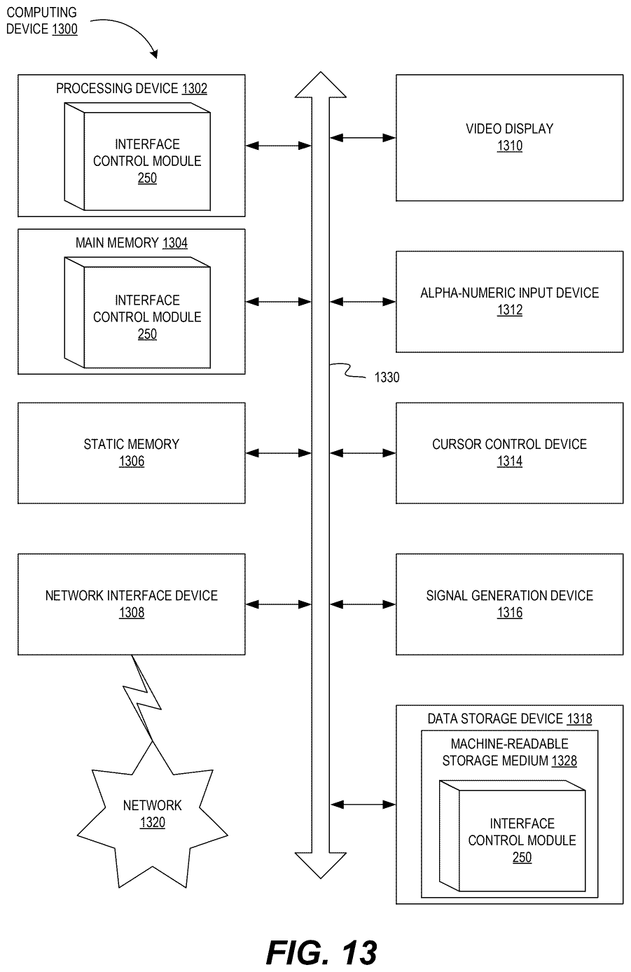

FIG. 13 is a block diagram of an example computing device 1300 that may perform one or more of the operations described herein, in accordance with some embodiments. Computing device 1300 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1300 may include a processing device 1302 (e.g., a general-purpose processor, a PLD, etc.), a main memory 1304 (e.g., synchronous dynamic random-access memory (DRAM), read-only memory (ROM)), a static memory 1306 (e.g., flash memory and a data storage device 1318), which may communicate with each other via a bus 1330.

Processing device 1302 may be provided by one or more general-purpose processing devices such as a microprocessor, central processing unit, or the like. In an illustrative example, processing device 1302 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1302 may also comprise one or more special-purpose processing devices such as an application specific integrated circuit (ASIC), a field programmable gate array (FPGA), a digital signal processor (DSP), network processor, or the like. The processing device 1302 may be configured to execute the operations described herein, in accordance with one or more aspects of the present disclosure, for performing the operations and steps discussed herein.

Computing device 1300 may further include a network interface device 1308 which may communicate with a network 1320. The computing device 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse) and an acoustic signal generation device 1316 (e.g., a speaker). In one embodiment, video display unit 1310, alphanumeric input device 1312, and cursor control device 1314 may be combined into a single component or device (e.g., an LCD touch screen).

Data storage device 1318 may include a computer-readable storage medium 1328 on which may be stored one or more sets of instructions, e.g., instructions for carrying out the operations described herein, in accordance with one or more aspects of the present disclosure. Instructions implementing the different systems described herein (e.g., interface system 1130 and/or interface control module 250 illustrated in FIG. 2) may also reside, completely or at least partially, within main memory 1304 and/or within processing device 1302 during execution thereof by computing device 1300, main memory 1304 and processing device 1302 also constituting computer-readable media. The instructions may further be transmitted or received over a network 1320 via network interface device 1308.

While computer-readable storage medium 1328 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “moving,” “determining,” “adjusting,” “activating,” “actuating,” “sliding,” “turning,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. An apparatus, comprising:
a display configured to present content to a user, wherein the display is movable between at least a first configuration and a second configuration;
a movement mechanism configured to move the display between the first configuration and the second configuration; and
a redirection device disposed adjacent to the display, wherein the redirection device is configured to redirect the content presented by the display to a viewing point when the display is in the first configuration.

2. The apparatus of claim 1, further comprising:
an input device configured to receive user input, wherein the movement mechanism moves the display between the first configuration and the second configuration based on the user input.

3. The apparatus of claim 1, wherein the content is presented to the user using a portion of the display when the display is in the first configuration.

4. The apparatus of claim 1, wherein the content is presented to the user using an entirety of the display when the display is in the second configuration.

5. The apparatus of claim 1, wherein the redirection device comprises one or more of a reflective surface and a refractive surface.

6. The apparatus of claim 1, wherein the display is not directly visible from the viewing point when the display is in the first configuration.

7. The apparatus of claim 1, wherein at least a portion of the display is directly visible from the viewing point when the display is in the second configuration.

8. The apparatus of claim 1, wherein the display obstructs a view of objects behind the display is in the second configuration.

9. The apparatus of claim 1, further comprising:
a control system configured to whether the display should be moved between the first configuration and the second configuration based on one or more conditions.

10. The apparatus of claim 9, wherein the one or more conditions comprises an operating mode of a vehicle.

11. The apparatus of claim 1, further comprising:
a second display configured to present content to a user, wherein the display is movable between at least a third configuration and a fourth configuration; and
a second movement mechanism configured to move the second display between the third configuration and the fourth configuration.

12. The apparatus of claim 1, wherein the display comprises a flexible display, wherein the flexible display is rolled in the first configuration, and wherein portions of the flexible display are substantially flat in the second configuration.

13. A method, comprising:
determining that a configuration of a display should be changed, wherein the display is configured to present content to a user and wherein the display is movable between at least a first configuration and a second configuration; and
activating a movement mechanism configured to move the display between the first configuration and the second configuration, wherein a redirection device is configured to redirect the content presented by the display to a viewing point when the display is in the first configuration.

14. The method of claim 13, wherein determining that the configuration of the display should be changed comprises receiving user input indicating that the configuration of the display should be changed.

15. The method of claim 14, wherein determining that the configuration of the display should be changed further comprises determine whether one or more conditions are satisfied.

16. The method of claim 15, wherein the one or more conditions comprises an operating mode of a vehicle.

17. The method of claim 15, wherein the one or more conditions comprise one or more of a number of users in a vehicle and locations of users in the vehicle.

18. A vehicle, comprising:
a display configured to present content to a user, wherein the display is movable between at least a first configuration and a second configuration;
a movement mechanism configured to move the display between the first configuration and the second configuration;
a redirection device disposed adjacent to the display, wherein the redirection device is configured to redirect the content presented by the display to a viewing point when the display is in the first configuration; and
an input device configured to receive user input, wherein the movement mechanism moves the display between the first configuration and the second configuration based on the user input.

19. The vehicle of claim 18, wherein the content is presented to the user using a portion of the display when the display is in the first configuration.

20. The vehicle of claim 18, wherein the content is presented to the user using an entirety of the display when the display is in the second configuration.
